(19) United States
(12) Patent Application Publication
(10) Pub. No.: US 2024/0377817 A1
(43) Pub. Date: Nov. 14, 2024

(54) METHOD AND DEVICE FOR CONTROLLING PRODUCTION SYSTEM BASED ON SIMULATION MODEL

(71) Applicants: China ENFI Engineering Corporation, Beijing (CN); China Nonferrous Engineering Co., Ltd., Beijing (CN)

(72) Inventors: CHU Jinwang, Beijing (CN); LIU Cheng, Beijing (CN); YAO Xin, Beijing (CN); PANG Hui, Beijing (CN); DING Shurong, Beijing (CN); ZHANG Yujie, Beijing (CN)

(73) Assignees: China ENFI Engineering Corporation, Beijing (CN); China Nonferrous Engineering Co., Ltd., Beijing (CN)

(21) Appl. No.: 18/651,005

(22) Filed: Apr. 30, 2024

(30) Foreign Application Priority Data
May 12, 2023 (CN) 202310534479.6
May 12, 2023 (CN) 202310534498.9

(51) Int. Cl. G05B 19/418

(52) U.S. Cl. CPC G05B 19/41835; G05B 2219/32337

(57) ABSTRACT

The invention provides a method and a device for controlling a production system based on a simulation model, belonging to the technical field of industrial process control. The main purpose of the invention is to improve the accuracy of identifying bottlenecks in the production system through a simulation model and to solve the problem that the existing operation rate obtained by simple estimation based on experience has a large error. The method comprises the following steps: connecting simulation modules based on the process flow of the production system to generate an initial simulation model, and optimizing the initial simulation model based on the maintenance parameters of the production system to obtain an optimized simulation model; Based on the optimized simulation model, identify the bottleneck of the production system or determine the operation rate of the production system.

### CROSS-REFERENCE TO RELATED APPLICATIONS

The application claims priority to Chinese patent application No. 202310534479.6 and 202310534498.9, filed on May 12, 2023, the entire contents of which are incorporated herein by reference.

### TECHNICAL FIELD

The application belongs to the technical field of industrial process control, and particularly relates to a method and a device for controlling a production system based on a simulation model.

### BACKGROUND

In the production system, if there is a bottleneck, it will easily lead to the mismatch between the production capacity and the buffering capacity of the production equipment, which will lead to the failure to achieve the target production capacity, and then lead to the underutilization of the production capacity of the equipment and the waste of investment. At present, the existing diagnosis method of bottleneck link is usually to directly observe the processing capacity of the equipment in a certain production process and the production equipment in the adjacent processes. If the processing capacity of the equipment in the production process is less than that of the equipment in the previous or subsequent production processes, it means that the equipment in the production process may be a bottleneck link, so as to diagnose the bottleneck link. However, the diagnosis of the bottleneck link only through simple comparison has a single dimension, which leads to low accuracy of the diagnosis results.

Operation rate is an important parameter in factory design and production operation and maintenance, and whether its value is accurate or not directly affects the infrastructure investment, operation cost and economic benefits of the factory. If the operation rate is too high, after the factory is completed and put into operation, the actual production capacity can not reach the preset operation rate, which will lead to the failure to reach the normal output, thus affecting the economic benefits and causing excessive investment. If the operation rate is small, it will lead to excess actual production capacity, which will lead to insufficient investment and also affect economic benefits. The traditional value of operation rate tends to be conservative, and usually a small value and a surplus coefficient are set to ensure the smooth production after production. However, this will easily lead to the actual production capacity being greater than the value of operation rate, resulting in insufficient investment. Moreover, because the production process is usually composed of multiple parts, the value of operation rate of each part is based on the value of upstream operation rate, and after repeated superposition, the deviation of overall operation rate is increased. In order to determine the operation rate more accurately, the existing technology mainly focuses on the following two methods. First, the operation rate of historical engineering projects similar to the current engineering projects is obtained, and then a coefficient is configured according to the actual situation of the current engineering projects, and the product of the operation rate of historical engineering projects and the coefficient is taken as the operation rate of the current engineering projects; Secondly, according to the production experience and data, set the operation time interval value and maintenance time interval value of the main equipment, and then estimate it through the formula. However, the above two methods rely on experience to make simple estimation, which leads to the error of the obtained operation rate.

### SUMMARY

In view of the above problems, the application discloses a method and a device for controlling a production system based on a simulation model, so as to overcome or at least partially solve the above problems.

In order to achieve the above purpose, the application adopts the following technical scheme:

The invention discloses a method for controlling a production system based on a simulation model, which comprises the following steps:

Connecting simulation modules based on the process flow of the production system to generate an initial simulation model, and optimizing the initial simulation model based on the maintenance parameters of the production system to obtain an optimized simulation model;

Based on the optimized simulation model, identify the bottleneck of the production system or determine the operation rate of the production system.

Further, the simulation model is an operation simulation model, and the identification of the bottleneck link of the production system includes:

Performing operation simulation processing on the current production system based on the operation simulation model of the current production system;

When the operation state of the operation simulation model is monitored to be in an abnormal state, acquiring abnormal state information corresponding to the abnormal state;

According to the abnormal state information, query the bottleneck link information in the bottleneck link mapping table of the production system, and determine the bottleneck link identification result corresponding to the abnormal state according to the bottleneck link information.

Furthermore, the method further comprises:

Acquire a bottleneck link adjustment scheme matching with the category according to the category of the bottleneck link identification result;

According to the bottleneck link adjustment scheme, the parameters of the operation simulation model are adjusted to obtain an adjusted operation simulation model.

Furthermore, the method further comprises:

Re-performing operation simulation processing on the current production system based on the adjusted operation simulation model;

If the adjusted operation simulation model is not monitored to be in an abnormal state within a preset time, complete the identification processing of the bottleneck link of the current production system.

Furthermore, connecting the simulation module based on the process flow of the production system to generate an initial simulation model, and optimizing the initial simulation model based on the maintenance parameters of the production system to obtain an optimized simulation model, including:

Connecting operation simulation modules and buffer modules corresponding to each process step contained in the current production system according to the process flow information of the current production system to generate an initial operation simulation model, wherein the buffer modules of the process steps are arranged adjacent to the operation simulation modules of the process steps;

Optimizing the initial operation simulation model according to the maintenance parameters of the current production system to obtain an optimized operation simulation model.

Furthermore, before connecting the operation simulation module and the buffer module corresponding to each process step contained in the current production system according to the process flow information of the current production system to generate the initial operation simulation model, the method further comprises:

According to the production capacity parameters and fault parameters of each process step contained in the current production system.

Furthermore, before connecting the operation simulation module and the buffer module corresponding to each process step contained in the current production system according to the process flow information of the current production system to generate the initial operation simulation model, the method further comprises:

According to the production capacity parameters and fault parameters of each process step, and arranging the buffer module at the adjacent position of the operation simulation module corresponding to the process step.

Furthermore, before connecting the operation simulation module and the buffer module corresponding to each process step contained in the current production system according to the process flow information of the current production system to generate the initial operation simulation model, the method further comprises:

Configuring a catch-up coefficient for an operation simulation module corresponding to each process step according to the configuration information of the buffer module corresponding to each process step to obtain an optimized operation simulation module of each process step;

Connecting the operation simulation module and the buffer module corresponding to each process step contained in the current production system according to the process flow information of the current production system to generate an initial operation simulation model, specifically comprising:

According to the process flow information of the current production system, the optimized operation simulation module and buffer module included in the current production system are connected to generate an initial operation simulation model.

Furthermore, the simulation model is a production simulation model, and determining the operation rate of the production system comprises:

Selecting a target operation rate determination rule from a plurality of preset operation rate determination rules in response to an operation rate determination instruction of the current production process;

Acquiring an operation rate determination element required by the target operation rate determination rule based on the production simulation model of the current production process flow;

Determining the operation rate of the current production process according to the operation rate determination element and the target operation rate determination rule.

Furthermore, connecting the simulation module based on the process flow of the production system to generate an initial simulation model, and optimizing the initial simulation model based on the maintenance parameters of the production system to obtain an optimized simulation model, including:

Connecting production simulation modules of each production process included in the current production process flow to generate an initial production simulation model of the current production process flow;

Optimizing the initial production simulation model based on the maintenance parameters of the current production process to obtain an optimized production simulation model.

Furthermore, before connecting the production simulation modules of each production process included in the current production process flow to generate the initial production simulation model of the current production process flow, the method further comprises:

Constructing a production simulation module corresponding to each production process according to the production parameters and fault parameters of each production process.

Furthermore, the method further comprises:

Respectively arranging buffering procedures at a plurality of preset positions in the current production process flow;

According to the production parameters and fault parameters of at least one production process adjacent to the buffering process, buffering parameters are configured for the buffering process, and obtain production simulation modules corresponding to each buffering process.

Furthermore, the method further comprises:

Adding the production simulation module corresponding to each buffering process to the corresponding preset position to complete the secondary optimization of the optimized production simulation model and obtain the secondary optimized production simulation model.

Furthermore, after adding the production simulation module corresponding to each buffering process to the corresponding preset position to complete the secondary optimization of the optimized production simulation model and obtain the secondary optimized production simulation model, the method further comprises:

According to the buffering parameters of each buffering process, a catch-up coefficient is configured for the production process adjacent to the buffering process to obtain a three-time optimized production simulation model;

The production simulation model based on the current production process flow obtains the operation rate determination elements required by the target operation rate determination rule, which specifically includes:

Acquiring an operation rate determination element required by the target operation rate determination rule based on the three-time optimized production simulation model of the current production process flow.

Furthermore, the preset operation rate determination rules include at least one of operation rate determination rules with production time as an operation rate determination element, operation rate determination rules with product output as an operation rate determination element, operation rate determination rules with raw material handling capacity as an operation rate determination element, and operation rate determination rules with fluid handling capacity as an operation rate determination element.

The application discloses a device for controlling a production system based on a simulation model, which comprises:

The simulation model generation and optimization unit is used for connecting simulation modules based on the technological process of the production system to generate an initial simulation model, and optimizing the initial simulation model based on the maintenance parameters of the production system to obtain an optimized simulation model;

The simulation model application unit is used for identifying the bottleneck link of the production system or determining the operation rate of the production system based on the optimized simulation model.

Furthermore, the simulation model is an operation simulation model, and the simulation model application unit further comprises:

The simulation processing subunit is used for performing operation simulation processing on the current production system based on the operation simulation model of the current production system;

An abnormal information acquisition module, configured to acquire abnormal state information corresponding to the abnormal state when monitoring that the operation state of the operation simulation model is in an abnormal state;

The bottleneck identification module is used for querying the bottleneck link information in the bottleneck link mapping table of the production system according to the abnormal state information, and determining the bottleneck link identification result corresponding to the abnormal state according to the bottleneck link information.

Furthermore, the simulation model is a production simulation model, and the simulation model application unit further comprises:

The selection module is used for responding to the operation rate determination instruction of the current production process, and selecting a target operation rate determination rule from a plurality of preset operation rate determination rules;

An acquisition module, configured to acquire an operation rate determination element required by the target operation rate determination rule based on the production simulation model of the current production process;

A determining module, configured to determine the operation rate of the current production process according to the operation rate determination element and the target operation rate determination rule.

The advantages and beneficial effects of the application are as follows.

The application provides a method and a device for controlling a production system based on a simulation model. Firstly, a simulation module is connected based on the process flow of the production system to generate an initial simulation model, and the initial simulation model is optimized based on the maintenance parameters of the production system to obtain an optimized simulation model; Then, based on the optimized simulation model, identify the bottleneck of the production system or determine the operation rate of the production system.

In the way of identifying the bottleneck of production system based on simulation model, firstly, the current production system is simulated based on the operation simulation model of the current production system; Secondly, when monitor that the operation state of the operation simulation model is in an abnormal state, acquire the abnormal state information corresponding to the abnormal state; Finally, the bottleneck link information in the bottleneck link mapping table of the production system is queried according to the abnormal state information, and the bottleneck link identification result corresponding to the abnormal state is determined according to the bottleneck link information. Compared with the prior art, the application simulates the operation of the production system and monitors its operation state; when an abnormal state occurs, acquire the abnormal state information of the simulation model of the current production system in the abnormal state, and the matching bottleneck link information in the bottleneck link mapping table of the production system is searched according to the information, and the bottleneck link corresponding to the matched bottleneck link information is taken as the bottleneck link causing the abnormal state, Based on the production capacity parameters and fault parameters of each process step contained in the current production system, the corresponding operation simulation module is constructed, and then the operation simulation model connected by each operation simulation module is optimized according to the maintenance parameters, so as to dynamically simulate the production system and find out the bottleneck link according to the simulation results, which overcomes the problem of single estimation dimension in the prior art and effectively improves the accuracy of bottleneck link identification.

In the way of determining the operation rate of the production system based on the simulation model, firstly, in response to the instruction of determining the operation rate of the current production process, select a target operation rate determination rule from a plurality of preset operation rate determination rules; Secondly, based on the production simulation model of the current production process, acquire the operation rate determination elements required by the target operation rate determination rules; Finally, the operation rate of the current production process is determined according to the operation rate determination elements and the target operation rate determination rules. Compared with the prior art, by establishing the production simulation model of the production process flow to simulate the whole production process flow, and then determining the operation rate of the current production process flow based on the production simulation model, the accuracy of selecting the operation rate is effectively improved; And by setting a number of preset rules to determine the operation rate, the purpose of determining the operation rate from multiple dimensions is realized. By horizontally comparing and screening the operation rates obtained from different dimensions, can further improve the accuracy of the operation rate.

### BRIEF DESCRIPTION OF DRAWINGS

Various other advantages and benefits will become clear to those skilled in the art by reading the following detailed description of the preferred embodiments. The drawings are only for the purpose of illustrating the preferred embodiments, and are not considered as limiting the application. Moreover, like parts are denoted by like reference symbols throughout the drawings. In the drawings:

FIG. 1 is a flowchart of a method for controlling a production system based on a simulation model provided by an embodiment of the present application;

FIG. 2 shows a flowchart of identifying bottlenecks in a production system provided by an embodiment of the present application;

FIG. 3 shows a flowchart of another method for identifying bottlenecks in a production system provided by an embodiment of the present application;

FIG. 4 shows a flowchart of a method for determining the operation rate provided by the embodiment of the application;

FIG. 5 shows a flowchart of another method for determining the operation rate provided by the embodiment of the present application;

FIG. 6 shows a statistical table of random faults provided by an embodiment of the present application;

FIG. 7 shows the maintenance plan provided by the embodiment of the application;

FIG. 8 shows a block diagram of a device for controlling a production system based on a simulation model provided by an embodiment of the present application.

### DETAILED DESCRIPTION OF THE EMBODIMENTS

In order to make the purpose, technical scheme and advantages of this application more clear, the technical scheme of this application will be described clearly and completely with specific embodiments of this application and corresponding drawings. Obviously, the described embodiment is only a part of the embodiment of this application, not the whole embodiment. Based on the embodiments in this application, all other embodiments obtained by ordinary technicians in this field without creative work belong to the protection scope of this application.

In the following, the technical scheme provided by each embodiment of the application will be described in detail with the drawings.

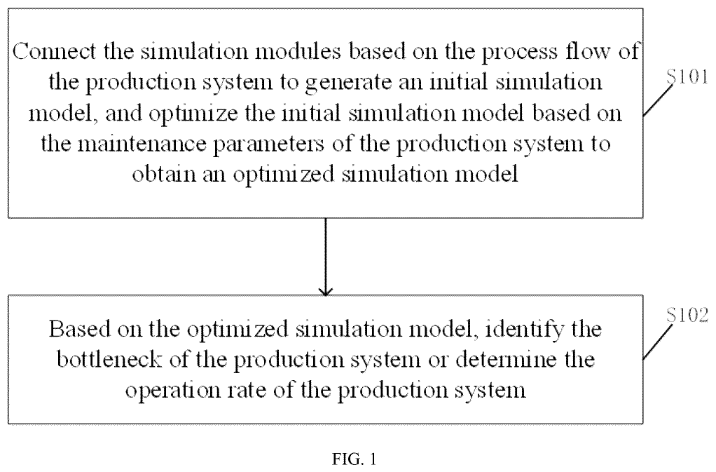

Refer to FIG. 1, which is a flowchart of a method for controlling a production system based on a simulation model provided by an embodiment of the present application. The method for controlling the production system based on the simulation model comprises the following steps S101-S102.

S101, connect the simulation modules based on the process flow of the production system to generate an initial simulation model, and optimize the initial simulation model based on the maintenance parameters of the production system to obtain an optimized simulation model;

S102: based on the optimized simulation model, identify the bottleneck of the production system or determine the operation rate of the production system.

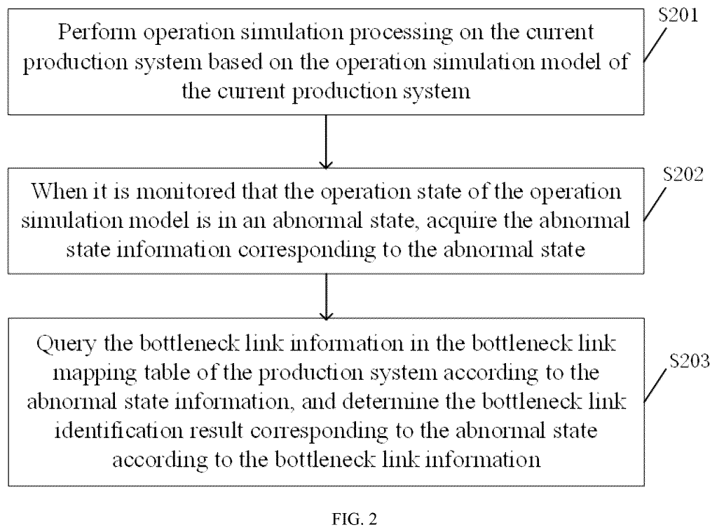

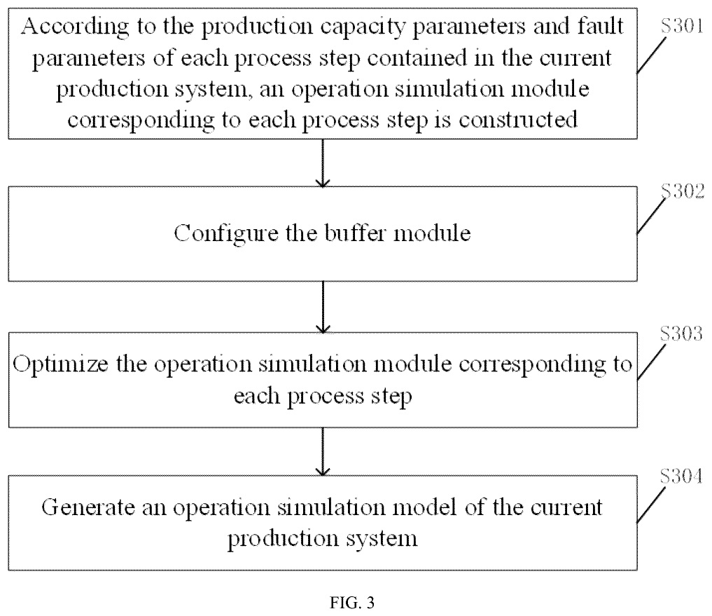

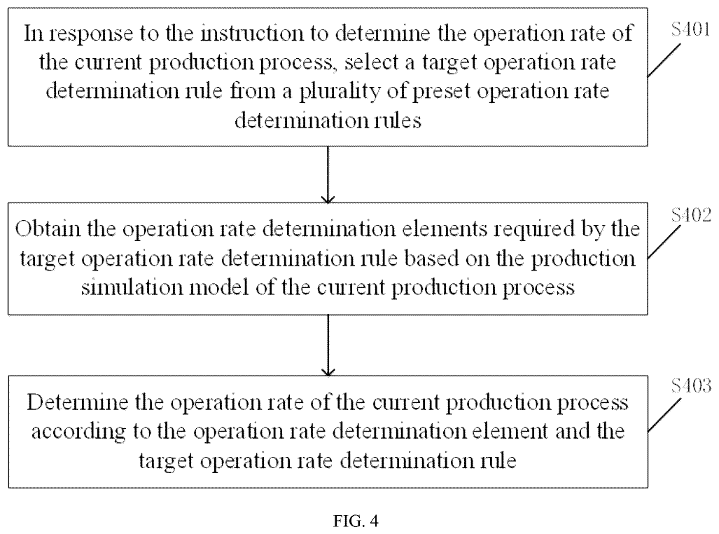

The following describes the embodiment of the application in detail from two aspects: identifying the bottleneck link (refer to FIG. 2-FIG. 3 and description) and determining the operation rate (refer to FIG. 4-FIG. 7 and description).

An embodiment of the present application provides a method for identifying bottlenecks in a production system, as shown in FIG. 2, which includes:

S201. Perform operation simulation processing on the current production system based on the operation simulation model of the current production system.

Wherein, the production system is used to characterize the whole process of a production process, such as the production system of a hydrometallurgy plant; The operation simulation model of the current production system is based on the production capacity parameters and fault parameters of each process step contained in the current production system to build the corresponding operation simulation module, and then optimize the operation simulation model connected by each operation simulation module according to the maintenance parameters of the current production system. In the embodiment of the present application, the current execution end may be the whole process control unit of the production system, etc., and the operation simulation processing is performed based on the pre-established operation simulation model of the current production system, so as to dynamically simulate the current production system.

It should be noted that the duration of operation the simulation can be the whole life cycle of the production system, or it can be one year, one quarter, etc., and the embodiment of the application is not specifically limited.

S202: When it is monitored that the operation state of the operation simulation model is in an abnormal state, acquire the abnormal state information corresponding to the abnormal state.

Wherein, the abnormal state is used to represent the operation state of the operation simulation model, such as a process step shutdown, or a buffer step without material or over full; The abnormal state information is the state information of each operation simulation module contained in the operation simulation model under an abnormal state, for example, the buffer step before process step A is over full, and the previous process step B and the subsequent process step C of process step A are stopped; Or there is no material in the buffering step before process step A, and the buffering step after process step A is over full. In the embodiment of the application, the operation state of the operation simulation model can be monitored according to a preset time or in real time, and when an abnormal state occurs, acquire the specific information of the process steps with abnormal state in the operation simulation model.

S203: Query the bottleneck link information in the bottleneck link mapping table of the production system according to the abnormal state information, and determine the bottleneck link identification result corresponding to the abnormal state according to the bottleneck link information.

Wherein, the mapping relationship between different abnormal state information and bottleneck links is recorded in the bottleneck link mapping table of the production system, including but not limited to: abnormal state information 1 (the previous process step B of process step A was forced to stop because the buffer step before process step A was over full, and the subsequent process step C of process step A was forced to stop because there was no production)—bottleneck link (process step A); Abnormal state information 2 (there is no material in the buffer step before process step A and the buffer step after process step A is over full)—bottleneck link (the processing capacity of process step A is too large); Abnormal state information 3 (when the previous process step B of buffer step A is in troubleshooting, the subsequent process step C of buffer step A is forced to stop due to no material production after consuming the temporarily stored materials in buffer step A, and the subsequent process step C is forced to stop due to the over full buffer step A during troubleshooting)—bottleneck link (buffer step A is a bottleneck link due to insufficient buffer capacity); Abnormal state information 4 (after the previous process step B of buffer step A is in failure and maintenance is completed, the subsequent process step C of buffer step A does not consume the materials temporarily stored in buffer step A, and after the subsequent process step C f is in failure and maintenance is completed, the buffer step A is not fully stored)—bottleneck link (the buffer capacity of buffer step A is too large, which is a bottleneck link); Abnormal state information 5 (when the previous process step B of buffer step A is troubleshooting, the subsequent process step C of buffer step A is forced to stop due to no material generation after consuming the temporarily stored materials in buffer step A, and the buffer step A is not fully stored after the subsequent process step C is in failure and maintenance is completed)—bottleneck link (buffer step A is a bottleneck link due to insufficient buffer capacity or unreasonable liquid level design); Abnormal state information 6 (after the previous process step B of buffer step A is in failure and maintenance is completed, the subsequent process step C of buffer step A does not consume the materials temporarily stored in buffer step A, and the previous process step B was forced to stop due to the over full buffer step A during the troubleshooting of subsequent process step C)—bottleneck link (the buffer step A is a bottleneck link due to insufficient buffer capacity or unreasonable liquid level design). In this embodiment of the application, according to the abnormal state information obtained in step S202 of the embodiment, the matching abnormal state information is searched in the bottleneck link mapping table of the production system, and the bottleneck link corresponding to the current abnormal state is determined based on this.

Compared with the prior art, in the embodiment of the application, the production system is run and simulated, and its operation state is monitored; when an abnormal state occurs, the abnormal state information of the simulation model of the current production system in the abnormal state is obtained, and a matching one is found in the bottleneck link information in the bottleneck link mapping table of the production system according to the information, and the bottleneck link corresponding to the matching bottleneck link information is taken as the bottleneck link causing the abnormal state, Based on the production capacity parameters and fault parameters of each process step contained in the current production system, the corresponding operation simulation module is constructed, and then the operation simulation model connected by each operation simulation module is optimized according to the maintenance parameters, so as to dynamically simulate the production system and find out the bottleneck link according to the simulation results, which overcomes the problem of single estimation dimension in the prior art and effectively improves the accuracy of bottleneck link identification.

An embodiment of the present application provides another method for identifying bottlenecks in a production system, as shown in FIG. 3, which includes:

S301. According to the production capacity parameters and fault parameters of each process step contained in the current production system, an operation simulation module corresponding to each process step is constructed.

In the embodiment of the application, the production capacity parameters include, but are not limited to, the material handling capacity, material relationship and other parameters of the process step; Fault parameters include, but are not limited to, the frequency of faults, the time required to eliminate faults (i.e. maintenance time), etc. It should be noted that the above failures are unplanned failures, that is, random failures.

Preferably, the production simulation module can be built based on the Agent. It should be noted that the agent can interact with the external environment independently and react to the external information, and has certain knowledge and learning ability. By using the active behavior of the entity to simulate, achieve simulation effects that are close to reality.

S302: Configure the buffer module.

In the embodiment of the application, in order to reduce the forced shutdown events caused by random failures, a buffer step can be arranged between two adjacent process steps, and when the upstream and downstream process steps fail, the processing capacity of the process steps that can still operate normally is stored through the buffer step, so that the production can be restored to the normal level through the adjustment of the processing capacity after the failure is repaired, thereby reducing the impact of random failures on the whole process. For example, taking the industrial processes of PAL and acid plants as examples, when the utilization rate of buffer step is lower than 30%, it will lead to the shutdown of downstream process steps, and when the utilization rate is higher than 90%, it will lead to the shutdown of upstream process steps. Configuring reasonable parameters for the buffer step based on the production capacity parameters and fault parameters of the process step can effectively improve the continuity and stability of the production system. Specifically, the parameters of the buffering step include a pre-stored buffer amount and a reserved buffer amount, wherein the pre-stored buffer amount is pre-stored in the buffering step in advance, and in order to ensure that the production of the subsequent process step is not affected until the fault repair of the previous process step, specifically, the pre-stored buffer amount=rated flow rate×fault repair time of the previous process step; The reserved buffer capacity is the empty volume in the buffer tank. When the subsequent process step fails to stop, it can store the material produced by the previous process step, so that the previous process step will not be affected until the subsequent process step is repaired. Specifically, the reserved buffer capacity=rated flow rate×fault repair time of the subsequent process step. Further, according to the processing flow rate of the process step and the unscheduled fault repair time of the process step, the pre-stored buffer amount and the reserved buffer amount of the buffer step are configured. For example, if the effective utilization volume of the buffer step is set within the range of 30%˜90%, then the volume of the buffer step=(pre-stored buffer amount+reserved buffer amount)/(90%−30%); Rated utilization rate of buffering step=(pre-stored buffer amount/buffer tank volume)+30%. Optionally, the utilization rate of the buffering step can be kept within the range of 5% above and below the rated utilization rate.

Accordingly, step S302 of the embodiment specifically includes configuring a buffer module for each process step according to the production capacity parameters and fault parameters of each process step, and arranging the buffer module in the adjacent position of the operation simulation module corresponding to the process step.

S303: Optimize the operation simulation module corresponding to each process step.

Because the buffer step is set between two adjacent process steps to store the materials produced by the previous process step when the current process step fails, it can be understood that the amount of materials in the buffer step will increase when the current process step stops. In this embodiment of the application, in order to quickly restore the production system to a normal state after the maintenance of the current process step is completed, can configure catch-up coefficient for each process step (that is, the percentage rate that the process step needs to perform beyond the normal production level, so as to restore the buffer capacity of the previous process step to the normal level after the process step resumes production), so as to restore to the normal state within a preset time. For example, it is stipulated that the recovery is within 7 days, and the catch-up coefficient=1+fault repair time of subsequent process steps/(7×24).

Accordingly, step S303 of the embodiment specifically includes: configuring a catch-up coefficient for the operation simulation module corresponding to each process step according to the configuration information of the buffer module corresponding to each process step, and obtaining the optimized operation simulation module of each process step.

S304: Generate an operation simulation model of the current production system.

In this embodiment of the application, an initial operation simulation model can be constructed based on SystemDynamics (SD for short) based on feedback control theory. Specifically, the operation simulation module and the buffer module optimized by the above-mentioned process steps are connected, including series connection, parallel connection and mixed connection. Further, in order to make the simulation effect closer to the real state of the current production system, the above-mentioned initial operation simulation model can be optimized based on the maintenance parameters of the current production system, wherein the maintenance parameters are obtained based on the planned maintenance scheme of the current production system. It can be understood that the production equipment will be troubleshooting regularly during the operation of the factory. Because the planned maintenance will cause the planned shutdown of the whole process, it is the main factor affecting the operation coefficient of the whole industrial process. Therefore, based on this, the simulation model is optimized to further improve the simulation effect.

It should be noted that system dynamics is a systematic analysis method that combines qualitative analysis with quantitative research to study social and economic management system, and its essence is a series of first-order differential equations with time delay based on causality diagram and flowchart. By emphasizing the viewpoint of system, connection, development and movement, it is used to study the complex information feedback relationship and changing trend among many factors in continuous dynamic systems. At the same time, the operation simulation model based on system dynamics is intuitive and logical, which makes it easy to describe the characteristics of complex systems.

Accordingly, step S304 of the embodiment specifically includes: connecting the optimized operation simulation module and buffer module of each process step contained in the current production system according to the process flow information of the current production system to generate an initial operation simulation model, and the buffer module of the process step is arranged at the adjacent position of the operation simulation module of the process step; According to the maintenance parameters of the current production system, the initial operation simulation model is optimized to obtain the optimized operation simulation model.

In an embodiment of the present application, in order to further define and explain, after step S203 of the embodiment, the method of the embodiment further includes: obtaining a bottleneck link adjustment scheme matching with the category according to the category of the bottleneck link identification result; According to the bottleneck link adjustment scheme, the parameters of the operation simulation model are adjusted to obtain the adjusted operation simulation model.

Wherein, the categories of bottleneck identification results include process step bottleneck and buffer step bottleneck. When the category of bottleneck identification result is process step category, the process step with abnormal state can be adjusted, and the adjustment items can include production capacity parameters and catch-up coefficient of process step. When the category of bottleneck identification result is buffer step category, the buffer step with abnormal state can be adjusted, and the adjustment items can include buffer capacity parameter, normal liquid level parameter and buffer step capacity, etc.

In an embodiment of the present application, for further limitation and explanation, the method of the embodiment further includes: re-performing operation simulation processing on the current production system based on the adjusted operation simulation model; If the adjusted operation simulation model is not monitored to be in an abnormal state within a preset time, complete the identification and processing of the bottleneck link in the current production system.

Wherein, the preset duration can be the whole life cycle of the production system, and it can also be one year, one quarter, etc., and the embodiment of this application is not specifically limited.

The application provides a method for identifying bottlenecks in a production system, which comprises the following steps: firstly, carrying out operation simulation processing on the current production system based on the operation simulation model of the current production system; Secondly, when monitoring that the operation state of the operation simulation model is in an abnormal state, acquiring abnormal state information corresponding to the abnormal state; Finally, the bottleneck link information in the bottleneck link mapping table of the production system is queried according to the abnormal state information, and the bottleneck link identification result corresponding to the abnormal state is determined according to the bottleneck link information. Compared with the prior art, in the embodiment of the application, the production system is operated and simulated, and its operation state is monitored; when an abnormal state occurs, acquire the abnormal state information of the simulation model of the current production system in the abnormal state, and a matching one is found in the bottleneck link information in the bottleneck link mapping table of the production system according to the information, and the bottleneck link corresponding to the matching bottleneck link information is taken as the bottleneck link causing the abnormal state, Based on the production capacity parameters and fault parameters of each process step contained in the current production system, construct the corresponding operation simulation module, and then the operation simulation model connected by each operation simulation module is optimized according to the maintenance parameters, so as to dynamically simulate the production system and find out the bottleneck link according to the simulation results, which overcomes the problem of single estimation dimension in the prior art and effectively improves the accuracy of bottleneck link identification.

The embodiment of the application provides a method for determining the operation rate, as shown in FIG. 4, which comprises the following steps:

S401: In response to the instruction to determine the operation rate of the current production process, select a target operation rate determination rule from a plurality of preset operation rate determination rules.

Wherein, the operation rate is the workload per unit time of the current production process, which can be daily operation rate, monthly operation rate, quarterly operation rate, annual operation rate, etc., and can also be the operation rate of all production processes in the whole process, an individual production process, or an individual equipment, etc., and the embodiment of this application is not specifically limited. Understandably, the whole process of the current production process from putting into production to scrapping and closing the production line is called the whole life cycle, including trial operation and normal production year. In addition, the preset operation rate determination rules can include the following operation rate determination rules: the operation rate determination rules with production time as the operation rate determination element, the operation rate determination rules with product output as the operation rate determination element, the operation rate determination rules with raw material handling capacity as the operation rate determination element, and the operation rate determination rules with fluid handling capacity as the operation rate determination element. In the embodiment of the present application, the current execution end can be the whole process control unit of the factory system, and when receiving the instruction for determining the operation rate of the current production process, it selects from the preset operation rate determination rules as the target operation rate determination rule. It should be noted that the selected target operation rate determination rules can be one or more. When multiple target operation rate determination rules are selected, multiple results of the current production process operation rate can be obtained based on multiple operation rate determination rules, so as to conduct horizontal comparison and screening, and further improve the accuracy of operation rate value.

S402: Obtain the operation rate determination elements required by the target operation rate determination rule based on the production simulation model of the current production process.

Wherein, the production simulation model is used to dynamically simulate the current production process. In the embodiment of the application, the operation rate determination rule includes a plurality of operation rate determination elements, and the operation rate under the operation rate determination rule can be obtained by calculating the corresponding operation rate determination elements based on the operation rate determination rule. It should be noted that the operation rate determination elements obtained based on the above production simulation model are obtained on the basis of dynamic simulation of production process, which is closer to the real situation of current production process, so the accuracy of operation rate can be effectively improved.

S403: Determine the operation rate of the current production process according to the operation rate determination element and the target operation rate determination rule.

In the embodiment of the application, taking the annual operation rate as an example, when the selected target operation rate determination rule is the operation rate determination rule with production time as the operation rate determination element, the annual operation rate=total annual production time/total annual time, and the unit of the determination element can be hours, minutes, seconds, etc., where the total operation rate of the factory is calculated based on the current production process flow as a whole, and the operation rates of production branches and single equipment are calculated based on branches; When the selected target operation rate determination rule is the operation rate determination rule with product output as the operation rate determination element, the annual operation rate=the annual output of Class A products/the annual output of Class A products without stopping, and the unit of determination element can be tons, kilograms, grams, etc. When the selected target operation rate determination rule is the operation rate determination rule with the raw material handling capacity as the operation rate determination element, the annual operation rate=the actual annual handling capacity of raw materials/the annual handling capacity of raw materials without stopping, and the unit of determination element can be tons, kilograms, grams, etc. When the selected target operation rate determination rule is the operation rate determination rule with fluid handling capacity as the operation rate determination element, the annual operation rate=actual annual fluid handling capacity/annual fluid handling capacity without stopping, and the unit of determination element can be cubic meters, liters, milliliters, tons, kilograms, grams, etc.

It should be noted that in the embodiment of this application, when determining the operation rate, the whole process flow is simulated based on the material flow, in which the material flow can be the whole solution, slurry, etc., and can also be a certain component or element in production.

Compared with the prior art, in the embodiment of the application, the production simulation model of the production process flow is established to simulate the whole production process flow, and then the operation rate of the current production process flow is determined based on the production simulation model, thus effectively improving the accuracy of selecting the operation rate; And by setting a number of preset rules to determine the operation rate, the purpose of determining the operation rate from multiple dimensions is realized. By horizontally comparing and screening the operation rates obtained from different dimensions, the accuracy of the operation rate can be further improved.

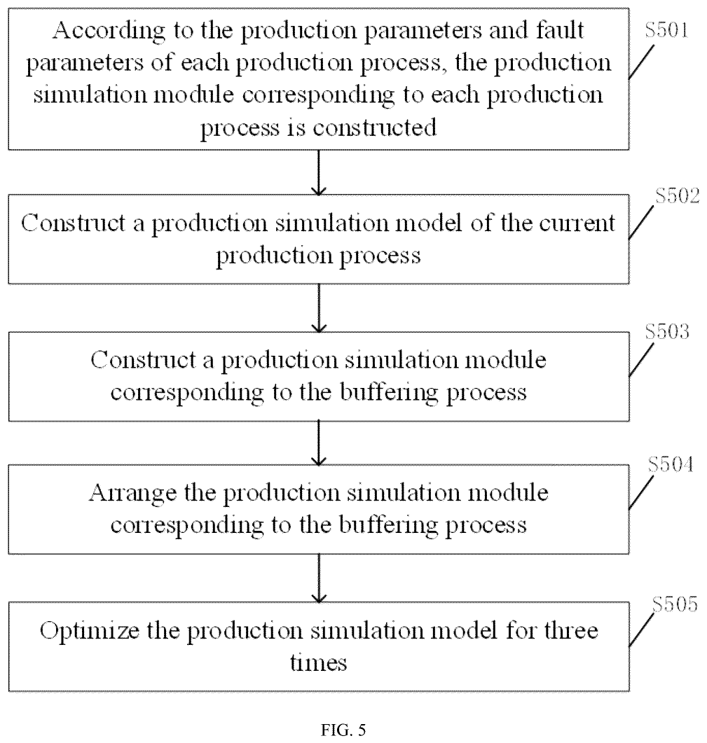

The embodiment of the application provides another method for determining the operation rate, as shown in FIG. 5, which includes:

S501. According to the production parameters and fault parameters of each production process, the production simulation module corresponding to each production process is constructed.

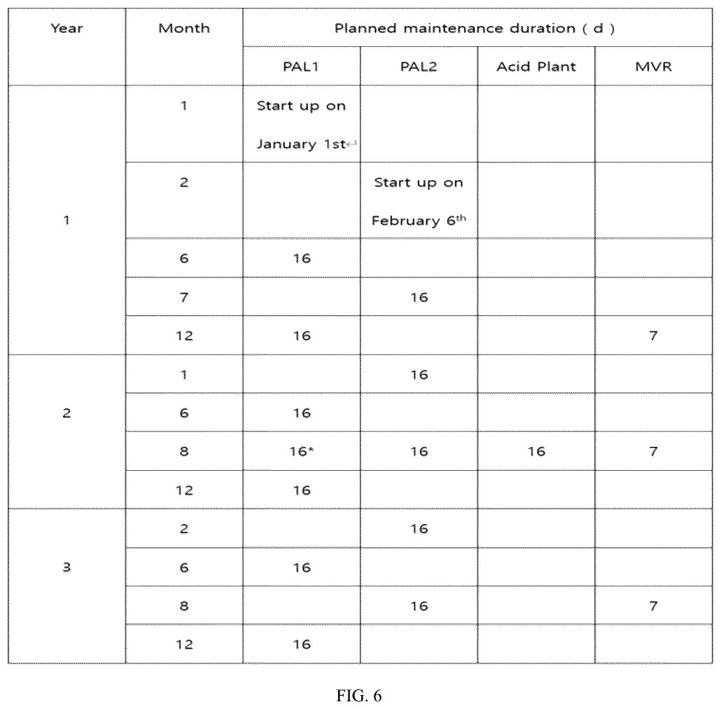

In the embodiment of the application, the production process is used to represent various production links contained in the production process flow, such as a production workshop, a production process, a production equipment, etc. The production parameters of the production process can include the processing capacity and material relationship of the production process. Fault parameters can include the frequency of faults, the time required to eliminate faults (i.e. maintenance time) and so on. It should be noted that the above failures are unplanned downtime, that is, random failures. Take the production process of PAL and acid plants as an example, and the statistical table of random failures is shown in FIG. 6. In the production process of PAL and acid plants, the unplanned downtime is mainly due to the random failures of PAL equipment and the failures of auxiliary systems (such as power supply or steam supply).

Preferably, the production simulation module can be constructed based on the Agent. It should be noted that the agent can interact with the external environment independently and react to the external information, and has certain knowledge and learning ability. By using the active behavior of the entity to simulate, the simulation effect is close to the reality.

S502: Construct a production simulation model of the current production process.

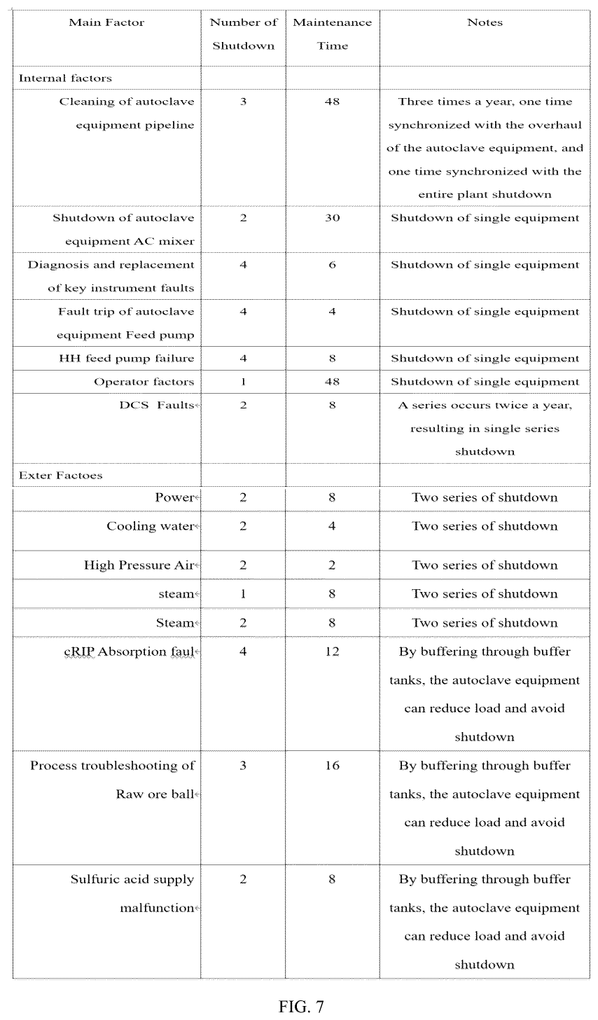

In the embodiment of this application, by connecting the production simulation modules corresponding to each production process constructed in step S501 of the embodiment together according to the process flow (including series connection, parallel connection and mixed connection), a multi-Agent system composed of a plurality of Agents is generated as an initial production simulation model, and the current production process flow is simulated through mutual coordination among the agents. Further, in order to make the simulation effect closer to the real state of the current production process, the initial production simulation model can be optimized based on the maintenance parameters of the current production process, wherein the maintenance parameters are obtained based on the planned maintenance scheme of the current production process. It can be understood that troubleshoot the production equipment regularly during the operation of the plant. Taking the production process of PAL and acid plant as an example, troubleshoot the autoclave equipment and MVR equipment regularly, and these two equipment overhauls will cause the planned shutdown of the whole process. An exemplary overhaul plan is shown in FIG. 7, in which each PAL device is stopped once every six months for 16 days, and troubleshoot two PAL devices in turn; troubleshoot the acid plant for the first time after 20 months of operation, and then troubleshoot regularly every 24 months; The ammonium sulfate MVR equipment will be shut down for 7 days of overhaul and maintenance. When a PAL equipment is out of service, MVR equipment will be arranged for maintenance at the same time. Because the planned maintenance will cause the planned shutdown of the whole process, which is the main factor affecting the operation coefficient of the whole production process, the optimization of the production simulation model based on this will further enhance the simulation effect.

Accordingly, step S502 of the embodiment specifically includes: connecting the production simulation modules of each production process included in the current production process flow to generate an initial production simulation model of the current production process flow; Based on the maintenance parameters of the current production process, optimize the initial production simulation model is optimized and obtain the optimized production simulation model.

S503: Construct a production simulation module corresponding to the buffering process.

In the embodiment of the application, in order to reduce the occurrence of shutdown due to unplanned failures, buffer processes can be respectively arranged at a plurality of preset positions in the production process flow, preferably, the preset positions can be between two adjacent production processes, so that when a certain production process fails, the products of the previous production process can be temporarily stored in the buffer process between the previous production process and the current production process, and the subsequent production process can be produced by using the materials stored in the buffer process between the current production process and the next production process. In addition, after the fault is eliminated in the current production process, the catch-up ability of the current production process can be used to run at a higher speed, so that the two buffering processes can be restored to normal levels. Wherein, the buffering parameters of the buffering process are configured according to the production parameters and fault parameters of the adjacent production processes.

Accordingly, step S503 of the embodiment specifically includes: respectively arranging buffering processes at a plurality of preset positions in the current production process flow; According to the production parameters and fault parameters of at least one production process adjacent to the buffering process, the buffering parameters are configured for the buffering process, and the production simulation modules corresponding to each buffering process are obtained.

S504: Arrange the production simulation module corresponding to the buffering process.

In the embodiment of the present application, the production simulation module corresponding to the buffering process constructed in step S503 of the embodiment is added to the preset position in the production process flow to obtain the secondary optimized production simulation model.

Accordingly, step S504 of the embodiment specifically includes: adding the production simulation modules corresponding to each buffering process to the corresponding preset positions, so as to complete the secondary optimization of the optimized production simulation model and obtain the secondary optimized production simulation model.

S505: Optimize the production simulation model for three times.

In the embodiment of the present application, in order to quickly restore the whole production process to the normal state after the maintenance of the production process is completed, a catch-up coefficient (that is, the percentage rate that the production process needs to perform beyond the normal production level, so that the buffer capacity of the previous production process can be restored to the normal level after the production process resumes production) can be configured for each production process, so as to restore the normal state within a preset time.

Specifically, step S505 of the embodiment specifically includes: allocating catching-up coefficients for production processes adjacent to the buffering process according to the buffering parameters of each buffering process, so as to obtain a production simulation model optimized for three times.

Based on this, step S402 of the embodiment specifically includes: acquiring the operation rate determination elements required by the target operation rate determination rule based on the production simulation model optimized three times in the current production process flow.

The application provides a method for determining the operation rate, which comprises the following steps: firstly, responding to a determination instruction of the current operation rate, selecting a target operation rate determination rule from a plurality of preset operation rate determination rules; Secondly, based on the production simulation model of the current production process, acquire the operation rate determination elements required by the target operation rate determination rule; And finally, determining the operation rate of the current production process according to the operation rate determination element and the target operation rate determination rule. Compared with the prior art, in the embodiment of the application simulate the whole production process flow by establishing the production simulation model of the production process flow, and then determine the operation rate of the current production process flow based on the production simulation model, thus effectively improving the accuracy of selecting the operation rate; And by setting a number of preset rules to determine the operation rate, the purpose of determining the operation rate from multiple dimensions is realized. By horizontally comparing and screening the operation rates obtained from different dimensions, the accuracy of the operation rate can be further improved.

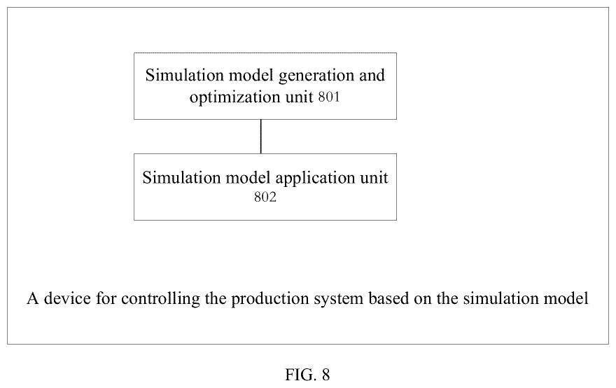

In addition, the embodiment of the application also provides a device for controlling the production system based on the simulation model. Referring to FIG. 8, a block diagram of a device for controlling a production system based on a simulation model provided by an embodiment of the present application is shown.

The device for controlling the production system based on the simulation model comprises:

A simulation model generation and optimization unit 801, configured to connect simulation modules based on the process flow of the production system to generate an initial simulation model, and optimize the initial simulation model based on the maintenance parameters of the production system to obtain an optimized simulation model;

A simulation model application unit 802, configured to identify the bottleneck of the production system or determine the operation rate of the production system based on the optimized simulation model.

In one implementation, the simulation model is an operation simulation model, and the simulation model application unit 802 further comprises:

The simulation module is used for carrying out operation simulation processing on the current production system based on the operation simulation model of the current production system;

An acquisition module, configured to acquire abnormal state information corresponding to the abnormal state when monitoring that the operation state of the operation simulation model is in an abnormal state;

The identification module is used for querying the bottleneck link information in the bottleneck link mapping table of the production system according to the abnormal state information, and determining the bottleneck link identification result corresponding to the abnormal state according to the bottleneck link information.

The acquisition module is further configured to acquire a bottleneck link adjustment scheme matching the category according to the category of the bottleneck link identification result;

An adjustment module, configured to adjust the parameters of the operation simulation model according to the bottleneck link adjustment scheme to obtain an adjusted operation simulation model.

Preferably, the device further comprises:

An updating module, which is used for re-simulating the current production system based on the adjusted operation simulation model;

The updating module is further configured to complete the identification of the bottleneck of the current production system if the adjusted operation simulation model is not monitored to be in an abnormal state within a preset time.

Preferably, the simulation model generation and optimization unit further comprises:

The connection module is used for connecting the operation simulation module and the buffer module corresponding to each process step contained in the current production system according to the process flow information of the current production system to generate an initial operation simulation model, and the buffer module of the process step is arranged adjacent to the operation simulation module of the process step;

The first optimization module is used for optimizing the initial operation simulation model according to the maintenance parameters of the current production system to obtain an optimized operation simulation model.

Preferably, the device further comprises:

And the construction module is used for constructing the operation simulation module corresponding to each process step according to the production capacity parameters and fault parameters of each process step contained in the current production system.

Preferably, the device further comprises:

The configuration module is used for configuring a buffer module for each process step according to the production capacity parameters and fault parameters of each process step, and arranging the buffer module at the adjacent position of the operation simulation module corresponding to the process step.

Preferably, the device further comprises:

A second optimization module, configured to configure a catch-up coefficient for the operation simulation module corresponding to each process step according to the configuration information of the buffer module corresponding to each process step, so as to obtain the optimized operation simulation module of each process step;

The connection module is specifically used for:

According to the process flow information of the current production system, the optimized operation simulation module and buffer module included in the current production system are connected to generate an initial operation simulation model.

In another implementation, the simulation model is a production simulation model, and the simulation model application unit 802 further comprises:

The selection module is used for responding to the operation rate determination instruction of the current production process, and selecting a target operation rate determination rule from a plurality of preset operation rate determination rules;

An acquisition module, configured to acquire an operation rate determination element required by the target operation rate determination rule based on the production simulation model of the current production process;

A determining module, configured to determine the operation rate of the current production process according to the operation rate determination element and the target operation rate determining rule.

Preferably, the simulation model generation and optimization unit 801 includes:

The connection module is used for connecting the production simulation modules of each production process included in the current production process flow to generate an initial simulation model of the current production process flow;

The optimization module is used for optimizing the initial simulation model based on the maintenance parameters of the current production process flow to obtain an optimized simulation model.

Preferably, the device further comprises:

And the construction module is used for constructing the production simulation module corresponding to each production process according to the production parameters and fault parameters of each production process.

Preferably, the device further comprises:

The arrangement module is used for respectively arranging buffering procedures at a plurality of preset positions in the current production process flow;

The first configuration module is used for configuring buffering parameters for the buffering process according to the production parameters and fault parameters of at least one production process adjacent to the buffering process to obtain production simulation modules corresponding to each buffering process.

Preferably, the device further comprises:

An adding module, configured to add the production simulation module corresponding to each buffering process to the corresponding preset position, so as to complete the secondary optimization of the optimized simulation model and obtain the secondary optimized simulation model.

Preferably, the device further comprises:

The second configuration module is used for configuring a catch-up coefficient for the production process adjacent to the buffering process according to the buffering parameters of each buffering process, so as to obtain a three-time optimized simulation model;

The acquisition module is specifically used for:

Acquiring an operation rate determination element required by the target operation rate determination rule based on the three-time optimized simulation model of the current production process flow.

Preferably, the preset operation rate determination rules include at least one of operation rate determination rules with production time as an operation rate determination element, operation rate determination rules with product output as an operation rate determination element, operation rate determination rules with raw material handling capacity as an operation rate determination element, and operation rate determination rules with fluid handling capacity as an operation rate determination element.

What has been described above is only the specific implementation of this application. Under the above teaching of this application, those skilled in the art can make other improvements or modifications on the basis of the above embodiments. It should be understood by those skilled in the art that the above detailed description is only to better explain the purpose of this application, and the protection scope of this application should be based on the protection scope of the claims.

In another implementation, the simulation model is a production simulation model, and the simulation model application unit 802 further comprises:

The selection module is used for responding to the operation rate determination instruction of the current production process, and selecting a target operation rate determination rule from a plurality of preset operation rate determination rules;

An acquisition module, configured to acquire an operation rate determination element required by the target operation rate determination rule based on the production simulation model of the current production process;

A determining module, configured to determine the operation rate of the current production process according to the operation rate determination element and the target operation rate determining rule.

Preferably, the simulation model generation and optimization unit 801 includes:

The connection module is used for connecting the production simulation modules of each production process included in the current production process flow to generate an initial simulation model of the current production process flow;

The optimization module is used for optimizing the initial simulation model based on the maintenance parameters of the current production process flow to obtain an optimized simulation model.

Preferably, the device further comprises:

And the construction module is used for constructing the production simulation module corresponding to each production process according to the production parameters and fault parameters of each production process.

Preferably, the device further comprises:

The arrangement module is used for respectively arranging buffering procedures at a plurality of preset positions in the current production process flow;

The first configuration module is used for configuring buffering parameters for the buffering process according to the production parameters and fault parameters of at least one production process adjacent to the buffering process to obtain production simulation modules corresponding to each buffering process.

Preferably, the device further comprises:

An adding module, configured to add the production simulation module corresponding to each buffering process to the corresponding preset position, so as to complete the secondary optimization of the optimized simulation model and obtain the secondary optimized simulation model.

Preferably, the device further comprises:

The second configuration module is used for configuring a catch-up coefficient for the production process adjacent to the buffering process according to the buffering parameters of each buffering process, so as to obtain a three-time optimized simulation model;

The acquisition module is specifically used for:

Obtaining an operation rate determination element required by the target operation rate determination rule based on the three-time optimized simulation model of the current production process flow.

Preferably, the preset operation rate determination rules include at least one of operation rate determination rules with production time as an operation rate determination element, operation rate determination rules with product output as an operation rate determination element, operation rate determination rules with raw material handling capacity as an operation rate determination element, and operation rate determination rules with fluid handling capacity as an operation rate determination element.

What has been described above is only the specific implementation of this application. Under the above teaching of this application, those skilled in the art can make other improvements or modifications on the basis of the above embodiments. It should be understood by those skilled in the art that the above detailed description is only to better explain the purpose of this application, and the protection scope of this application should be based on the protection scope of the claims.

What is claimed is:

1. A method for controlling a production system based on a simulation model, characterized in that comprising:
connecting simulation modules based on the process flow of the production system to generate an initial simulation model, and optimizing the initial simulation model based on the maintenance parameters of the production system to obtain an optimized simulation model;
based on the optimized simulation model, identify the bottleneck of the production system or determine the operation rate of the production system.

2. The method according to claim 1, characterized in that the simulation model is an operation simulation model, and the identification of the bottleneck link of the production system comprises:
performing operation simulation processing on the current production system based on the operation simulation model of the current production system;
when the operation state of the operation simulation model is monitored to be in an abnormal state, acquiring abnormal state information corresponding to the abnormal state;
according to the abnormal state information, query the bottleneck link information in the bottleneck link mapping table of the production system, and determine the bottleneck link identification result corresponding to the abnormal state according to the bottleneck link information.

3. The method according to claim 2, characterized in that the method further comprises:
acquire a bottleneck link adjustment scheme matching with the category according to the category of the bottleneck link identification result;
according to the bottleneck link adjustment scheme, the parameters of the operation simulation model are adjusted to obtain an adjusted operation simulation model.

4. The method according to claim 3, characterized in that the method further comprises:
re-performing operation simulation processing on the current production system based on the adjusted operation simulation model;
if the adjusted operation simulation model is not monitored to be in an abnormal state within a preset time, complete the identification processing of the bottleneck link of the current production system.

5. The method according to claim 2, characterized in that connecting the simulation module based on the process flow of the production system to generate an initial simulation model, and optimizing the initial simulation model based on the maintenance parameters of the production system to obtain an optimized simulation model, including:
connecting operation simulation modules and buffer modules corresponding to each process step contained in the current production system according to the process flow information of the current production system to generate an initial operation simulation model, wherein the buffer modules of the process steps are arranged adjacent to the operation simulation modules of the process steps;
optimizing the initial operation simulation model according to the maintenance parameters of the current production system to obtain an optimized operation simulation model.

6. The method according to claim 5, characterized in that b before connecting the operation simulation module and the buffer module corresponding to each process step contained in the current production system according to the process flow information of the current production system to generate the initial operation simulation model, the method further comprises:
according to the production capacity parameters and fault parameters of each process step contained in the current production system.

7. The method according to claim 6, characterized in that before connecting the operation simulation module and the buffer module corresponding to each process step contained in the current production system according to the process flow information of the current production system to generate the initial operation simulation model, the method further comprises:
according to the production capacity parameters and fault parameters of each process step, and arranging the buffer module at the adjacent position of the operation simulation module corresponding to the process step.

8. The method according to claim 7, characterized in that before connecting the operation simulation module and the buffer module corresponding to each process step contained in the current production system according to the process flow information of the current production system to generate the initial operation simulation model, the method further comprises:
configuring a catch-up coefficient for an operation simulation module corresponding to each process step according to the configuration information of the buffer module corresponding to each process step to obtain an optimized operation simulation module of each process step;
connecting the operation simulation module and the buffer module corresponding to each process step contained in the current production system according to the process flow information of the current production system to generate an initial operation simulation model, specifically comprising:
according to the process flow information of the current production system, the optimized operation simulation module and buffer module included in the current production system are connected to generate an initial operation simulation model.

9. The method according to claim 1, characterized in that the simulation model is a production simulation model, and determining the operation rate of the production system comprises:
selecting a target operation rate determination rule from a plurality of preset operation rate determination rules in response to an operation rate determination instruction of the current production process;
acquiring an operation rate determination element required by the target operation rate determination rule based on the production simulation model of the current production process flow;
determining the operation rate of the current production process according to the operation rate determination element and the target operation rate determination rule.

10. The method according to claim 9, characterized in that connecting the simulation modules based on the process flow of the production system to generate an initial simulation model and optimizing the initial simulation model based on the maintenance parameters of the production system to obtain an optimized simulation model comprises:
connecting production simulation modules of each production process included in the current production process flow to generate an initial production simulation model of the current production process flow;
optimizing the initial production simulation model based on the maintenance parameters of the current production process to obtain an optimized production simulation model.

11. The method according to claim 10, characterized in that before connecting the production simulation modules of each production process included in the current production process flow to generate the initial production simulation model of the current production process flow, the method further comprises:
constructing a production simulation module corresponding to each production process according to the production parameters and fault parameters of each production process.

12. The method according to claim 10, characterized in that the method further comprises:
respectively arranging buffering procedures at a plurality of preset positions in the current production process flow;
according to the production parameters and fault parameters of at least one production process adjacent to the buffering process, buffering parameters are configured for the buffering process, and obtain production simulation modules corresponding to each buffering process.

13. The method according to claim 12, characterized in that the method further comprises:
adding the production simulation module corresponding to each buffering process to the corresponding preset position to complete the secondary optimization of the optimized production simulation model and obtain the secondary optimized production simulation model.

14. The method according to claim 12, characterized in that after adding the production simulation module corresponding to each buffering process to the corresponding preset position to complete the secondary optimization of the optimized production simulation model and obtain the secondary optimized production simulation model, the method further comprises:
according to the buffering parameters of each buffering process, a catch-up coefficient is configured for the production process adjacent to the buffering process to obtain a three-time optimized production simulation model;
the production simulation model based on the current production process flow obtains the operation rate determination elements required by the target operation rate determination rule, which specifically includes:
acquiring an operation rate determination element required by the target operation rate determination rule based on the three-time optimized production simulation model of the current production process flow.

15. The method according to claim 9, characterized in that the preset operation rate determination rules include at least one of operation rate determination rules with production time as an operation rate determination element, operation rate determination rules with product output as an operation rate determination element, operation rate determination rules with raw material handling capacity as an operation rate determination element, and operation rate determination rules with fluid handling capacity as an operation rate determination element.

16. A device for controlling a production system based on a simulation model, characterized in that comprising:
the simulation model generation and optimization unit is used for connecting simulation modules based on the technological process of the production system to generate an initial simulation model, and optimizing the initial simulation model based on the maintenance parameters of the production system to obtain an optimized simulation model;
the simulation model application unit is used for identifying the bottleneck link of the production system or determining the operation rate of the production system based on the optimized simulation model.

17. The device according to claim 16, characterized in that the simulation model is an operation simulation model, and the simulation model application unit further comprises:
the simulation processing subunit is used for performing operation simulation processing on the current production system based on the operation simulation model of the current production system;
an abnormal information acquisition module, configured to acquire abnormal state information corresponding to the abnormal state when monitoring that the operation state of the operation simulation model is in an abnormal state;
the bottleneck identification module is used for querying the bottleneck link information in the bottleneck link mapping table of the production system according to the abnormal state information, and determining the bottleneck link identification result corresponding to the abnormal state according to the bottleneck link information.

18. The device according to claim 16, characterized in that the simulation model is a production simulation model, and the simulation model application unit further comprises:
the selection module is used for responding to the operation rate determination instruction of the current production process, and selecting a target operation rate determination rule from a plurality of preset operation rate determination rules;
an acquisition module, configured to acquire an operation rate determination element required by the target operation rate determination rule based on the production simulation model of the current production process;
a determining module, configured to determine the operation rate of the current production process according to the operation rate determination element and the target operation rate determination rule.
